(19) United States
(12) Patent Application Publication
(10) Pub. No.: US 2006/0082723 A1
(43) Pub. Date: Apr. 20, 2006

(54) Eyeglasses with alternative supports

(76) Inventors: Shahrooz S. Jamie, Clay, WV (US); Sharon S. Jamie, Clay, WV (US)

Correspondence Address: BOWLES RICE MCDAVID GRAFF & LOVE LLP, POST OFFICE BOX 1386, CHARLESTON, WV, 25325-1386, US

(21) Appl. No.: 10/968,641

(22) Filed: Oct. 19, 2004

(51) Int. Cl. G02C 5/14

(52) U.S. Cl. 351/123

(57) ABSTRACT

Eyeglasses, with alternative supports for maintaining the bridge of the glasses off the nasal bone or other parts of the bridge, useful for patients of rhinoplasty. In one embodiment, the bridge of a conventional pair of glasses is supplemented with extensions to below the outer half of each lens and positioned to rest on the cheek bones of the face. In another embodiment, the typical bridge is eliminated and a horizontal support arch is provided which joins at and extends beyond the lower edge of each lens. A pair of nasolabial supports are provided, one each of which is disposed on either end of the support arch, which is further comprised of a pad which rests within and is supported by the nasolabial arch, or the fold between the side of the nose and cheek. In a third embodiment, the bridge is eliminated and a lip support bar is provided which rests upon the upper lip and which has upturned ends which articulate with the lower edges of the lenses. A pair of support pads joining the lower edges of the lenses and disposed laterally from the upturned ends of the lip support bar may also be provided, which rest upon the cheek bones. A final embodiment is comprised of a conventional eyeglass frame with a lip support pad disposed below the bridge for support on the upper lip and two support members, each support member having one end articulating with the lip support pad and another end articulating tangentially with the lateral edge of one lens.

### BACKGROUND OF THE INVENTION

1. Field of the Invention

The invention disclosed herein relates to eyeglasses and eyeglass frames with alternative means of support on the face.

2. Description of the Related Art

Eyeglasses are commonly used to correct vision impairments and as well as to protect the eyes in hazardous environments. Typical eyeglass frames are comprised of common structures for positing the frame on the face of the wearer. These structures include temple arms, one end of which loops behind the ears, and a nose bridge or nose pads attached to the nose bridge, which rest upon the nose of a wearer. The two ear loops on the temple arms and the nose bridge or pads provide three points of contact with the face of the user, which provides sufficient support to maintain the frames in a desired position and alignment. The nose bridge or pads support a majority of the weight of the frames. The end loops of the temple arms engage with the cartilage of the ears and prevent the frame from sliding away from or down the nose.

Rhinoplasty, or cosmetic surgery to reshape the nose, is one of the more commonly administered forms of cosmetic surgery procedures. According to the American Society of Plastic Surgeons, in the year 2002 approximately 354,327 rhinoplasty procedures were performed. A substantial recovery period is involved after rhinoplasty, during which the nose is swollen, inflamed and painfully sensitive to touch or pressure. The inflammation and sensitivity usually preclude use of common types of eyeglass frames.

In other cases, the use of conventional eyeglass frames is undesirable because the nose pads cause indentation marks in the skin of the nose, or pull flaccid skin downward, causing cosmetically unappealing wrinkles in the skin around the nose.

The use of contact lenses may alleviate these undesirable consequences, but cannot be worn by or are uncomfortable to many people. Further, contact lenses do not provide any physical protection to the eye, and hard lenses disposed anterior of the eye are still necessary to provide this protection, as well as vision correction.

A number of examples of modified eyeglass frames are available in the prior art. For example, U.S. Pat. No. 182,013, issued to Andross on Sep. 12, 1876; U.S. Pat. No. 1,026,272, issued to Leveque on May 14, 1912 and U.S. Pat. No. 1,819,738, issued to Daniels on Feb. 23, 1928, each disclose a spectacles or eyeglasses wherein the lenses are supported by a frame that completely encircles the rear of the head. The spectacles are maintained on the head by pressing the frame around the lenses against the socket surrounding the eye using tension in the frame. This method can be uncomfortable and cause irritation to the skin around the eye socket.

U.S. Pat. No. 3,955,885, issued to Aronsohn on May 11, 1976, and U.S. Pat. No. 5,666,182, issued to Donner each disclose an eyeglass frame with a support member disposed, either permanently or removably, to the lower edge of the frame. These are capable of supporting the eyeglass frame off the bridge of the nose, but the positioning of the support member along the lower frame edge causes an obstruction to the downward field of vision, a disadvantage especially for those with bifocal lenses.

An eyeglass frame which supports the frame off the bridge of the nose without interfering with the normal field of vision is desirous.

### SUMMARY OF THE INVENTION

To alleviate or improve upon the disadvantages in the prior art, modifications to conventional eyeglass frames comprise a variety of elements to provide support for the frames on other portions of the wearer's face or head. These alternative support points position the eyeglass frames properly without the need for contact with the nasal bridge.

In one embodiment, the eyeglass frame is held in place by a modified bride having a pair of extended support members. The extended bridge support member replaces the bridge in a conventional pair of eyeglasses. The extended bridge support member is comprised of two extended support members that articulate with a bridge at their upper ends and each engages with the medial edge of one lens near the upper end. The support members then further downward and laterally in a gentle arc, terminating at a lower end below the lenses, approximately vertically aligned with the lateral edge of the lens. A support cushion or pad. of various configurations, is disposed on the lower end of the extended support members. The support members are shaped to have contact with the cheek area of the face with the lower end of the extended support member, without the upper ends of each support member nor the bridge connecting the two contacting the nasal bone.

In a second embodiment of the invention, the convention bridge is eliminated and replaced with a support arch that is disposed generally horizontally, engaging with the lower or inferior edges of the lenses near their vertical central axes. A pair of nasolabial attachments is disposed to either end of the support bar, slightly laterally from the point of engagement with the lens. The nasolabial attachments are directed medially to provide a point of contact with the nasolabial fold next to the nose.

In a third embodiment of the invention, the conventional bridge is again eliminated, and replaced with a lip support bar. The lip support bar extends horizontally below the two lenses, more inferiorly than the support bar in the second embodiment, and extending to where the lip support bar may rest on the upper lip when the glasses are donned. The ends of the lip support bar are comprised of vertical sections which extend to articulate with the lower edges of the lenses. For further stability, a pair of support pads is disposed on the lower edges of the lenses, lateral from the points where the ends of the lip support bar articulate with the edges of the lens.

In a fourth embodiment of the invention, a lip support member is provided on a conventional pair of eyeglasses. The lip support member is comprised of a support pad, disposed medially below the bridge and which rests upon the upper lip of the wearer. The support pad engages with the eyeglass frame by two support members, each of which articulates at one end with the reverse side of the support pad on the lip and extend laterally on either side and upward to where the other end of each support member articulates tangentially with the lateral edge of either lens.

One objective of this invention is to provide an eyeglass frame with means for elevating the bridge on a typical frame off the nasal bridge.

Another objective is to support an eyeglass frame on the face by a part of the face or head other than the nasal bridge.

Another objective of this invention is to provide such means without impeding vision, especially in the downward direction.

These and other objectives and advantages of the invention will become apparent from the description which follows. In the description, reference is made to the accompanying drawings, which from a part hereof, and in which is shown by way of illustration specific embodiments in which the invention may be protected. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views.

The following detailed description is, therefore, not to be taken in a limiting sense, and the scope of the present invention is best defined by the appended claims.

### DESCRIPTION OF THE DRAWINGS

FIG. 1 is a diagram displaying a conventional pair of eyeglasses in use.

FIG. 2 is a front elevation orthogonal view of a first embodiment of the invention.

FIG. 3 is a side elevation orthogonal view of a first embodiment of the invention.

FIG. 4 is a front elevation orthogonal view of a second embodiment of the invention.

FIG. 5 is a side elevation orthogonal view of a second embodiment of the invention.

FIG. 6 is a front elevation orthogonal view of a third embodiment of the invention.

FIG. 7 is a side elevation orthogonal view of a third embodiment of the invention.

FIG. 8 is a front elevation orthogonal view of a fourth embodiment of the invention.

FIG. 9 is a side elevation orthogonal view of a fourth embodiment of the invention.

### DETAILED DESCRIPTION OF THE INVENTION

The following discussion describes in detail one or more embodiments of the invention. The discussion should not be construed, however, as limiting the invention to those particular embodiments, and practitioners skilled in the art will recognize numerous other embodiments as well. The complete scope of the invention is defined in the claims appended hereto.

As used herein, the following words or terms have the indicated meaning:

“Inferior” or “inferiorly” means downward, towards the feet.

“Superior” or “superiorly” means upward, towards the top of the head.

“Lateral” or “laterally” means horizontally or in a horizontal direction away from the sagittal plane, either left, right, or both.

“Medial” or “medially” means horizontally or in a horizontal direction towards the sagittal plane of the body.

“Parasagittal” or “parasagitally” means in a plane parallel to the sagittal plane of the body.

“Sagittal” or “sagittally” means in a vertical plane passing through the vertical centerline of the body and dividing the body into right and left halves.

“Anterior” or “anteriorly” means towards the front of the body.

“Posterior” or “posteriorly” means towards the back of the body.

When the above anatomically related directions or orientations are used in reference to the disclosed invention, reference to the invention is based on the invention donned in the customary manner or in the manner described for use on the face of a wearer.

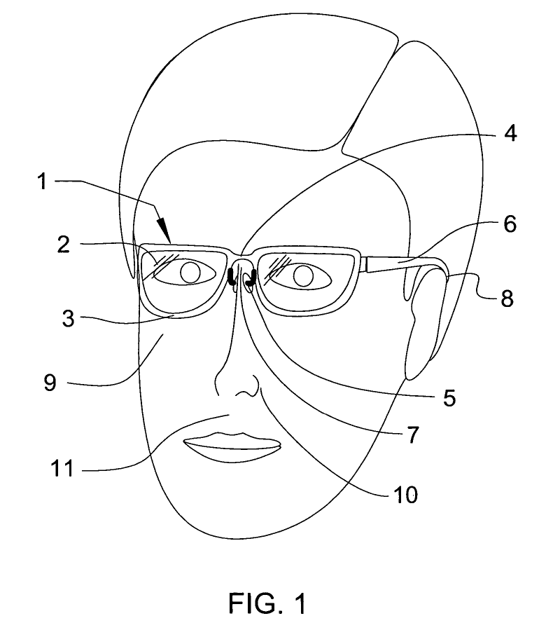

As shown in FIG. 1, a typical pair of conventional eyeglasses in the prior art is comprised of a pair of transparent lenses, each possibly enclosed within a circuitous frame, connected by a bridge, together forming an eyeglass frame. On the lateral edge of each frame is disposed a temple arm, comprised of an elongated member engaged, usually pivotally, to the eyeglass frame at one end and having an arcuate ear loop at the other end. The bridge is either shaped to conform with the shape of a typical nasal bridge, or has disposed on it a pair of nose pads, which are either adjustable or fixed, designed to rest upon the nasal bone.

The typical pair of eyeglasses is worn by resting the bridge 4, or the nose pads 5 if so equipped, on the nasal bone 7 and then engaging the ear loops 8 with the rear of the ear lobes. The friction of the nose pads 5 prevent the eyeglass frame from sliding down the nose, while the tension from the ear loops 8 maintain the eyeglass frame 1 in vertically in front of the eyes.

In some designs, the temple arms 6 are rigidly disposed at an angle generally perpendicular to the plane of the eyeglass frame 1. In other designs, the temple arms 6 pivotally engage with the eyeglass frame 1, permitting each temple arm to pivot and flex to a closed position behind and parallel to the plane of the eyeglass frame 1. When in use, the temple arms 6 are extended to the open position, perpendicular to the plane of the eyeglass frame 1. When the eyeglasses are donned by a wearer, the eyeglass frame 1 is substantially coplanar with the frontal plane of the wearer, and the temple arms 6 are coplanar with a parasagittal plane on either side of the head.

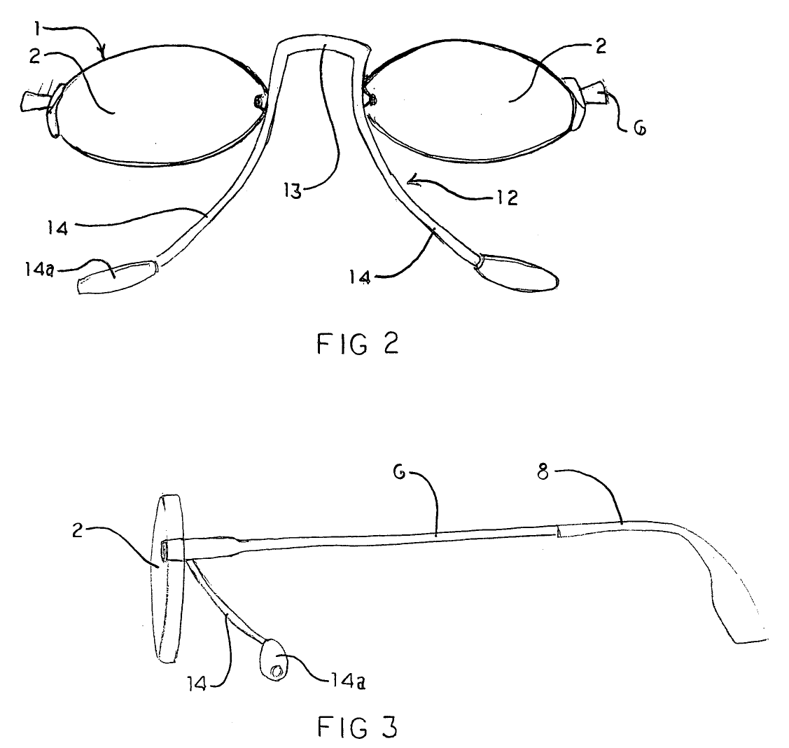

To achieve the objective of the present invention in providing a means for elevating the eyeglass frame off 1 the nasal bone 7 and supporting it by another part of the face or head, the invention disclosed herein, in one type of embodiment, utilizes an extended bridge support member. As shown in FIG. 2, the bridge 4 of a conventional eyeglass frame is replaced with an extended bridge support member 12. The extended bridge support member 12 is comprised of a medial horizontal center section 13, disposed medially between the two lenses. The extended bridge support member 12 is further comprised of a pair of extended support arms 14. Each extended support arm 14 is thin and curvilinear, manufactured preferably of metal. An upper end of each extended support arm engages with an end of the horizontal center section 13 at a substantially perpendicular angle. The extended support arms b14 also engage with the inner, or medial edges of each lens 2, or the circuitous frame 3 surrounding each lens 2, if so provided. The distance between the points of engagement with the end of the horizontal center section 13 and the medial edge of the lens is equal for both support members, and sufficient to provide clearance of the horizontal center section 13 above the nasal bone 7 (shown in FIG. 1) when the glasses are donned. The horizontal center section is generally wider than the bride of conventional glasses, again to provide clearance from the nose.

Each extended support member extends downward (inferiorly) and outward (laterally), terminating at a lower end which is parasagittally aligned approximately with the lateral edge of the respective lens 2. The lower end is also disposed slightly posterior of the frontal plane of the lenses 2. In this configuration, the lower ends of the extended support arms 14 will engage and rest upon the outer cheek bone 9 of the face, shown in FIG. 1, with the bridge section elevated above the nasal bone 7 shown in FIG. 1. The lower end of the extended support arms 4 preferably has an augmented diameter 14a or width to increase the area of contact with the skin surface, thereby increasing comfort as well as the frictional force for holding the extended support member in place on the cheek.

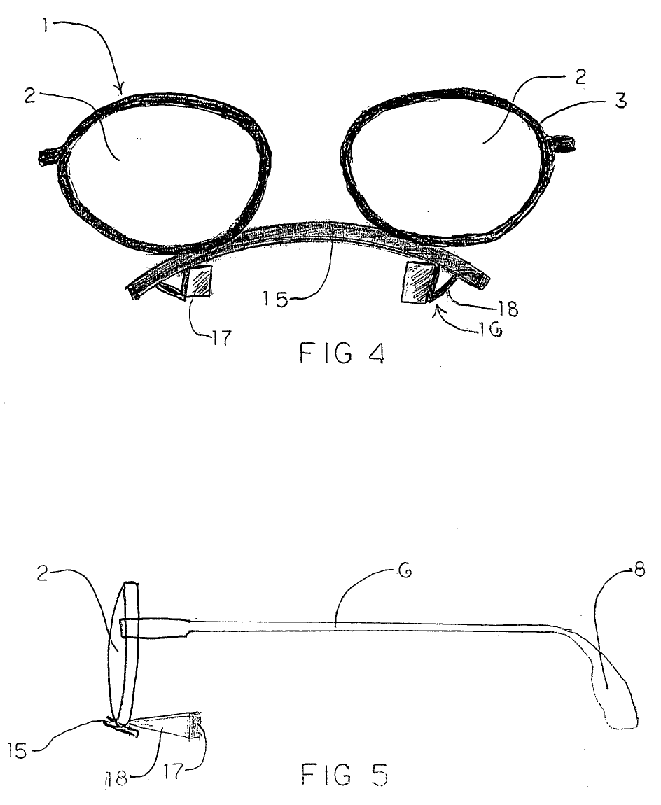

In a second embodiment of the invention, as shown in FIGS. 4 and 5, the bridge of a convention pair of glasses has been eliminated and replaced with a support arch 15 disposed horizontally and laterally under the two lenses 2, engaging the lenses 2, or their circuitous frames 3 if so provided, on their lower edges approximately at the vertical centerline. The ends of the support arch 15 may extend laterally beyond the engagement with the lenses 2 or circuitous frames 3. Preferably, the support arch 15 has a slight curvature in the frontal plane.

This second embodiment is further comprised of a pair of nasolabial attachments 16. The nasolabial attachments 16 are disposed on either side of the support arch 15, preferably proximate to the engagement with the lenses 2. The nasolabial attachments 16 are comprised of a pad and an elongated member 18. The elongated member b18 has a first end which articulates with the support arch 15 and a second end, opposite the first, which engages with the pad 17. The pad 17 is generally planar in shape, such as a circular or rectilinear disk, with an obverse and reverse side. The second end of the elongated member 18 articulates with either the reverse surface or one of the lateral edges of the pad 17. The obverse side is positioned to rest in the nasolabial fold 10, the fold or crease of skin where the side of the nose joins with the cheek. The obverse side may have a layer of cushioning material, such as felt or an elastomeric material, to provide comfort and friction for a more stable fit.

The nasolabial attachments 16 are disposed so as to have, when the eyeglasses are donned, the support arch 15 elevated slightly above or in front of the nose and other part of the face when the obverse surface of the pad 17 of each nasolabial attachment 16 rests against the nasolabial fold 10, in FIG. 1. Thus, the eyeglasses are supported on the face solely by the nasolabial attachments 16 against the side of the nose and the ear loops 8 behind the ears.

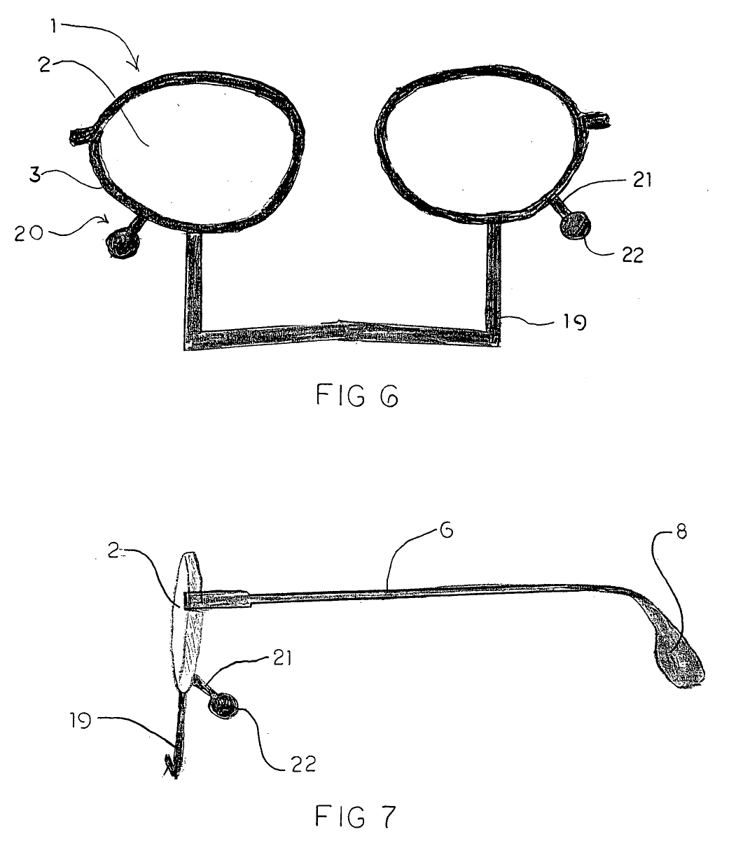

In a third embodiment of the invention, shown in FIGS. 6 and 7, the bridge of a conventional pair of eyeglasses is again eliminated and replaced with the lip support bar 19. The lip support bar 19 serves both to structurally support the lenses 2 as well as to elevate the eyeglass frame 1 off the nasal bone 7 (in FIG. 1). The lip support bar 19 is an elongated member 18 with a generally horizontal center section and two vertical sections at either end. The lip support bar 19 should be thick enough to provide sufficient stiffness for isolating the lenses 2. The end of each vertical section articulate with the lower edge of one or the other lens 2, or its circuitous frame 3 if so provided. The center, horizontal section of the lip support bar 19 may be slightly arcuate to match the contour of the upper lip 11, in FIG. 1 for better comfort when in use.

This embodiment also includes, preferably, a pair of second support members 20, each of which is disposed laterally from either side of the lip support bar 19. Each of the second support members 20 is comprised of a support arm 21 and a second pad 22. The second pad 22 is in the shape of a disk, having an obverse and a reverse side. One end of the support arm 21 articulates with the reverse side of the second pad, and the other end of the support arm 21 articulates with the inferior lateral edge of the lens 2 or circuitous frame 3. The support arms' 21 positions are adjusted so that the obverse sides rest comfortably on the cheek bone, or zygomatic bone, shown as reference 9 in FIG. 1, while the lip support bar 19 rests on the upper lip 11 and the ear loops 8 engage the top and rear of the ear.

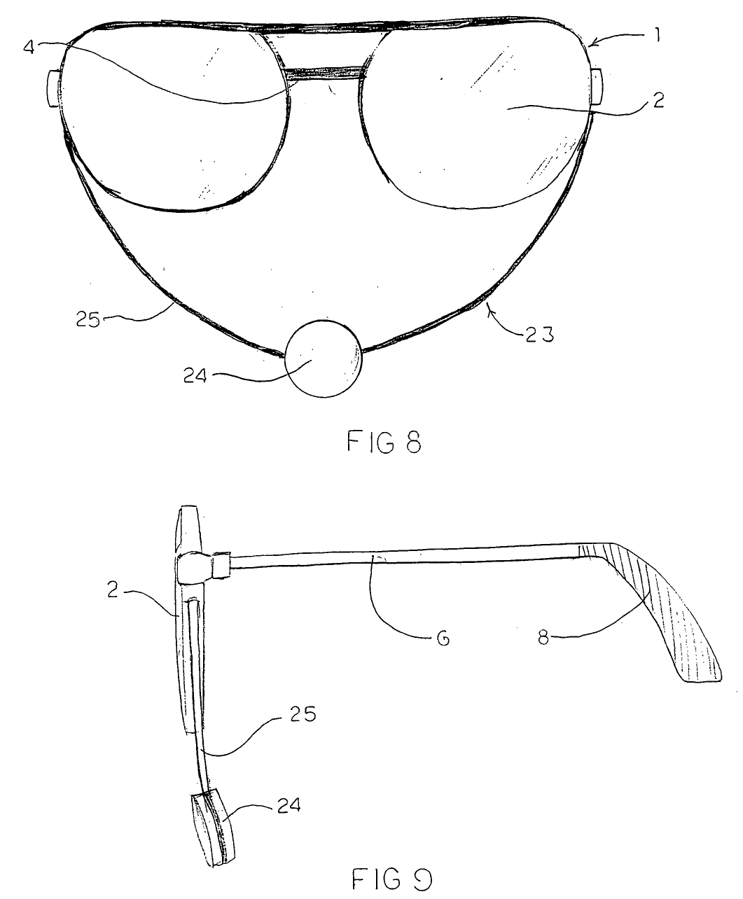

In a fourth embodiment of the invention, as shown in FIGS. 8 and 9, the bridge of a convention eyeglass frame is maintained, and is augmented with a lip support member 23 which is comprised of a lip support pad 24 and two second support arms 25. The lip support pad 24 is shaped as a disk, with an obverse and a reverse surface. In the preferred embodiment it is fabricated of a non-corrosive metal, such as stainless steel or gold- or nickel-plated metal. It may also be fabricated from a variety of polymeric resins, such as high density polyethylene, and others known in the art. It may have a cushioning layer, made of felt or an elastomer, on the obverse surface for comfort when resting on the surface of the upper lip 11.

One end of each second support arm 25 is secured either to the edge on to the reverse surface of the lip support pad 24, using solder, adhesives or other methods known in the art. Each of the second support arms 24 are curved outward and upward, to where the other end of each second support arm 25 tangentially articulates with the lateral edge of each lens 2 or its circuitous frame 3.

In use, the two second support arms 25 are shaped manually to have the bridge of the eyeglass frame disposed above the nasal bone when the obverse surface of the lip support pad 24 rests on the upper lip and the ear loops 8 engage with the top and rear of the ear.

While various embodiments of the invention have been described above, it should be understood that they have been presented by way of example, and not limitation. It will be apparent to person skilled in the relevant art that various changes in form and detail may be made therein without departing from the spirit, and scope and application of the invention. This is especially true in light of technology and terms within the relevant art that may be later developed. Thus, the present invention should not be limited by any of the above-described exemplary embodiments, but should only be defined in accordance with the appended claims and their equivalents.

We claim:

1) Eyeglasses with alternative supports, comprised of:
a) a pair of lenses;
b) a pair of temple arms, each having a proximal and a distal end, an ear loop disposed at the distal end of each temple arm, and each temple arm articulating with one of the pair of lenses;
c) an extended bridge section, comprised of a linear center section disposed between the two lenses and aligned parallel and superior to the collinear axis of the lenses, and two curvilinear support arms, each support arm articulating at a first end with one end of the center section, articulating with the medial edge of one of the lenses proximate to its first end and extending laterally and inferiorly to a second end disposed lateral from the vertical centerline of the lens.

2) The eyeglasses with alternative supports of claim 1, wherein the second end of each of the support arms is disposed lateral of the lateral parasagittal plane of the lens.

3) The eyeglass frame with alternative supports of claim 1, wherein the second end of each of the support arms is disposed between the vertical centerline and the lateral parasagittal plane of the lens.

4) The eyeglasses with alternative support of claim 1, wherein the diameter of the second end of each support arm is greater than the first end.

5) Eyeglasses with alternative supports, comprised of:
a) a pair of lenses;
b) a pair of circuitous frames, each circuitous frame circumscribing and enclosing one of the pair of lenses;
c) a pair of temple arms, each having a proximal and a distal end, an ear loop disposed at the distal end of each temple arm, and each temple arm articulating with one of the pair of circuitous frames;
d) an extended bridge section, comprised of a linear center section disposed between the two circuitous frames and aligned substantially parallel and superior to the collinear axis of centers of the lenses, and two curvilinear support arms, each support arm articulating at a first end with one end of the center section, articulating with the medial edge of one of the circuitous frames proximate to its first end and extending laterally and inferiorly to a second end disposed lateral from the vertical centerline of the lens of the circuitous frame to which the support arm articulates.

6) The eyeglasses with alternative supports of claim 5, wherein the second end of each of the support arms is disposed lateral of the lateral parasagittal plane of the circuitous frame.

7) The eyeglasses with alternative supports of claim 5, wherein the second end of each of the support arms is disposed between the vertical centerline of the lens and the lateral parasagittal plane of the circuitous frame.

8) The eyeglasses with alternative support of claim 5, wherein the diameter of the second end of each support arm is greater than the first end.

9) Eyeglasses with alternative supports, comprised of:
a) a pair of lenses, each lens having a medial, lateral and inferior edge;
b) a pair of temple arms, each of the temple arms having a distal end with an ear loop disposed thereon and a proximal end articulating with a lateral edge of one of the pair of the lenses;
c) an elongated curvilinear support arch, said support arch having a first and a second ends, said support arch articulating proximal to the first end with the inferior edge of one lens and articulating proximal to the second end with the inferior edge of the other lens;
d) a pair of support members, each support member having a pad, said pad in the shape of a disk having an obverse and a reverse sides, and a support arm, said support arm articulating at a first end with the reverse surface of the pad and articulating at a second end with the support arch.

10) The eyeglasses with alternative supports of claim 9, wherein the support members are disposed laterally from the articulation of the support arch with the edge of the lens.

11) The eyeglasses with alternative supports of claim 9, further comprised of a cushioning layer disposed on the obverse surface of each pad.

12) The eyeglasses with alternative supports of claim 9, further comprised of a pair of circuitous frames, each circuitous frame circumscribing and enclosing one of the two lenses, wherein the articulation of the proximal ends of the temple arms and the two articulations of the support arch are with the circuitous frame.

13) Eyeglasses with alternative supports, comprised of:
a) a pair of lenses, each lens having a medial, lateral and inferior edge;
b) a pair of temple arms, each temple arm having a distal end with an ear loop disposed thereon and a proximal end articulating with the lateral edge of one lens;
c) a bridge, disposed medially between the two lenses;
d) a lip support bar, comprised of an elongated curvilinear center section and two elongated curvilinear end sections each having first and second ends, said first ends of the end sections orthogonally with either end of the center section and articulating at the second end with the inferior edge of either of the two lenses, and said center section substantially parallel to the collinear axis of the centers of the two lenses.

14) The eyeglasses with alternative supports of claim 13, further comprised of a pair of support members, each of said support members comprised of an elongated arm with a first end articulating with the inferior edge of one of the lenses and a second end; and further comprised of a pair of support pads, each having an obverse and reverse surface, said second end of each of the support members articulating with the reverse surface of one of the support pads.

15) The eyeglasses with alternative supports of claim 14, further comprised of a cushioning layer disposed on the obverse surface of the support pad.

16) The eyeglasses with alternative supports of claim 13, further comprised of a pair of circuitous frames, wherein each circuitous frame circumscribes and encloses one of the pair of lenses, and wherein the articulation of the proximal end of each temple arms and the two articulations with the lip support bar are with the circuitous frame.

17) Eyeglasses with alternative supports, comprised of:
a) a pair of lenses, each lens having a medial, lateral and inferior edge;
b) a pair of temple arms, each temple arm having a distal end with an ear loop disposed thereon and a proximal end articulating with the lateral edge of one lens;
c) a bridge disposed medially between the two lenses;
d) two elongated curvilinear support members, each having a first end which articulates tangentially with the lateral edge of one lens and extends medially and inferiorly to a second end disposed inferior to the bridge; and
e) a support pad, disposed inferiorly of the bridge and to which articulates each second end of the two support members.

18) The eyeglasses with alterative supports of claim 17, further comprised of a pair of circuitous frames, each of which circumscribes and encloses one lens, and to which the proximal end of the temple arm and the first end of the support member articulates.

19) The eyeglasses with alternative supports of claim 17, wherein the support pad is planar with an obverse and a reverse surface and the second ends of the support members articulate with the reverse surface.
